(19) United States
(12) Patent Application Publication
(10) Pub. No.: US 2006/0101290 A1
(43) Pub. Date: May 11, 2006

(54) Method for multiple scheduled computer powers-on

(76) Inventor: Yu-Ming Ma, Taipei Hsien (TW)

Correspondence Address: LIN & ASSOCIATES INTELLECTUAL PROPERTY, P.O. BOX 2339, SARATOGA, CA, 95070-0339, US

(21) Appl. No.: 10/983,181

(22) Filed: Nov. 6, 2004

(51) Int. Cl. G06F 1/26

(52) U.S. Cl. 713/300

(57) ABSTRACT

A method of scheduling multiple automatic powers-on for a computer is provided. The multiple automatic powers-on are achieved by repeatedly reconfiguring the automatic power-on function of the computer's BIOS. The method provides a configuration software module and a renewal software module. The configuration software module, when executed, allows a user to specify at least a schedule event through a user interface for powering on the computer at a specific date and time, along with other information relevant to the schedule event. The configuration software module also stores the schedule events into a schedule database. On the other hand, the renewal software module, when triggered, retrieves from the schedule database a schedule event that has a future scheduled date and time closest to the current date and time. The renewal software module then directly updates the automatic power-on configuration of the BIOS so that, at the specified date and time, the computer is powered on automatically by the automatic power-on function of the BIOS.

### BACKGROUND OF THE INVENTION

1. Field of the Invention

The present invention generally relates to the automatic power-on of computers and, more particularly, to a method for automatically powering on computers by repeatedly updating the BIOS configuration.

2. The Prior Arts

As more and more tasks are executed and completed by computers, there has long been a need for computers to automatically and unattendedly execute various tasks at specific times. Modern computer operating systems are usually equipped with capability for such scheduled and automated operations such as data backup, virus scan, database cleanup, disk defragmentation, information download, video recording (with appropriate hardware and software) etc. However, a computer must remain powered on and its operating system must be active in order for these scheduled operations to happen, which would cause a significant waste of electric power. On the other hand, the Basic Input Output System (BIOS) of computers also provides the capability of powering on the computers automatically at specific times when the computers are not running. This of course avoids the electric power consumption for keeping the computers powered on. However, replying on the BIOS for automatic scheduled operations is very inconvenient. For example, in order to set up a computer's next automatic power-on, a user has to reboot the computer, activate the BIOS configuration utility, and then updated the BIOS settings manually.

In addition, the BIOS has very limited memory space and usually only one scheduled power-on can be specified. If a user requires multiple scheduled powers-on, the user has to wait until the previous operation is completed, reboot the computer, activate the BIOS configuration utility, and set up the next power-on schedule manually. Therefore, the requirement for multiple scheduled computer powers-on is yet to have an appropriate solution.

Accordingly, the present invention is directed to overcome the memory space limitation of the BIOS to achieve a large number of scheduled powers-on.

### SUMMARY OF THE INVENTION

An objective of the present invention is to provide a method for scheduling multiple automatic powers-on for a computer. The method repeatedly updates the BIOS automatic power-on configuration so that the computer is powered on automatically at the scheduled dates and times. The method effectively obviates the common limitation of the BIOS that only one or very small number of automatic powers-on can be scheduled.

Based on the foregoing objective, the method of the present invention provides a configuration software module and a renewal software module. The configuration software module, when executed, allows a user to specify at least a schedule event through a user interface for powering on a computer at a specific date and time, along with other information relevant to the schedule event. The configuration software module also stores the schedule events into a schedule database. On the other hand, the renewal software module, when triggered, searches and retrieves from the schedule database a schedule event that has a future scheduled date and time closest to the current date and time. The renewal software module then directly updates the automatic power-on configuration of the BIOS so that, at the moment specified by the schedule event, the computer is powered on automatically by the automatic power-on function of the BIOS.

On the other hand, the present invention could provide in the computer's BIOS a power-on flag indicating the condition under which the computer is powered on. By examining the power-in flag, the system and method of the present invention is able to accurately determine the condition causing the computer to power on.

If a computer's BIOS is configured so that a power-on password is required when the computer is powered on, in order to avoid that the automatic power-on procedure is stopped waiting for a user input, the method of the present invention could store the power-on password and reconfigure the BIOS so that no power-on password is required. In addition, the present invention could also provide a special setting in the BIOS so that, when a computer is powered on automatically at a specified time, the step of requesting the power-on password is bypassed.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing a computer capable of scheduling multiple automatic powers-on according a preferred embodiment of the present invention.

### DETAILED DESCRIPTION OF THE PREFERRED EMBODIMENTS

In the following, detailed description along with the accompanied drawings is given to better explain preferred embodiments of the present invention. Please be noted that, in the accompanied drawings, some parts are not drawn to scale or are somewhat exaggerated, so that people skilled in the art can better understand the principles of the present invention.

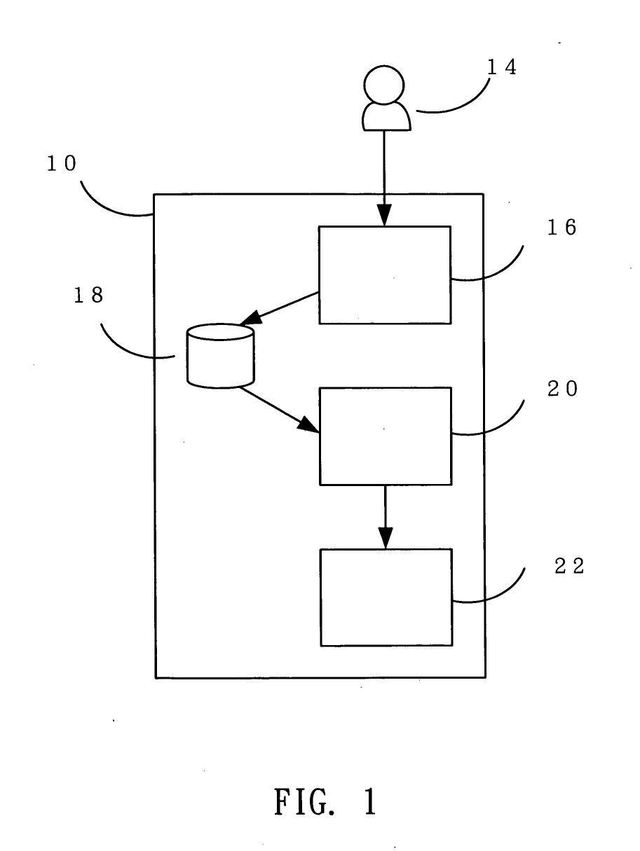

FIG. 1 is a schematic diagram showing a computer capable of scheduling multiple automatic powers-on according a preferred embodiment of the present invention. As shown in FIG. 1, a computer 10 is provided with a configuration software module 16, a renewal software module 20, and a schedule database 18. In certain embodiments, both or one of the configuration software module 16 and the schedule database 18 are located outside of the computer 10, as long as both the configuration and renew software modules 16 and 20 can access the schedule database over some communication interface (such as LAN). In the most basic operation scenario, the renewal software module 20, when the computer 10 is powered on and running, searches and retrieves from the schedule database 18 a schedule event that has a future scheduled date and time closest to the current date and time. The renewal software module 20 then directly updates the automatic power-on configuration of computer 10's BIOS 22. Later after the computer 10 is shut down, the automatic power-on function of computer 10's BIOS 22 would automatically power on the computer 10 at the specified date and time, so that the computer 10 returns to a running state.

As shown in FIG. 1, a user 14 of the computer 10 executes the configuration software module 16, and specifies, updates, and stores a number of schedule events for powering on the computer 10 automatically into the schedule database 18, via a user interface (not shown). In a certain embodiment of the present invention, schedule events can also be entered by other application programs (also not shown) running on or outside the computer 10. A schedule event mainly comprises information such as the specific date and time for powering on computer 10.

The renewal software module 20's searching the schedule database 18 and updating BIOS 22's configuration can be triggered under two circumstances. One is when there is a new schedule event is entered or an existing schedule event is updated in the schedule database 18, either by the user 14 using the configuration software module 16 or by other application programs. The other circumstance is when the current time has passed the latest scheduled automatic power-on date and time, and after the computer 10 is automatically powered on.

When the computer 10 is shut down and is inoperative, and when the latest scheduled automatic power-on date and time has expired, BIOS 22's automatic power-on function would power on the computer 10 automatically. Then, according to the other triggering circumstance mentioned above, the renewal software module 20 searches in the schedule database 18 for a schedule event whose scheduled date and time are nearest to the current date and time. The renewal software module 20 then updates the BIOS 22's automatic power-on configuration accordingly. In this way, the present invention's objective for scheduling multiple automatic powers-on is thereby achieved.

Currently, the automatic power-on function of most computers' BIOS allows users to schedule an event at a certain second, certain minute, and certain hour on a certain day in a certain month. However, there are still some computers' BIOS can only schedule an event at a certain second, certain minute, and certain hour only (i.e., no day and month). For these computers, the scheduling of a power-on on a certain day in a certain month is achieved as follows according to the present invention. When the renewal software module 20 searches the schedule database 18 and finds the next power-on's scheduled date and time, if the next power-on's scheduled date and time and the current date and time are within 24 hours, the renewal software module 20 then updates BIOS 22's configuration appropriately (i.e., using only the time part and ignoring the date part of the schedule). On the other hand, if the next power-on's scheduled date and time are later than the current date and time for more than 24 hours, the renewal software module 20 update the BIOS 22's configuration so that the computer 10 would be powered on automatically at the specific second, minute, and hour within the next 24 hours. After the computer 10 is shut down and the configured power-on time is expired, the computer 10 would be powered on automatically as expected. The renewal software module 20 would be triggered as well, according the foregoing description of the two triggering circumstances. The renewal software module 20 would then update the BIOS 22's automatic power-on configuration based on whether the scheduled power-on date and time are within 24 hours or not. The renewal software module 20 would also determine that timing is not right to power on the computer 10 and therefore shutdown the computer 10 automatically. The scenario would be repeated on a daily basis. For example, the current time is 05:00:00 PM on August 12^{th}, and the user 14 enters a schedule event into the schedule database 18 to power on the computer 10 at 10:00:00 AM on August 14^{th}. As the scheduled power-on date and time are 24-hour later than the current date and time, the renewal software module 20 therefore update the BIOS 22's configuration so that the BIOS is scheduled to power on computer 10 at 10:00:00 AM on August 13^{th}. After the computer 10 is shut down and when the time passes 10:00:00 AM on August 13^{th}, the computer 10 is powered on by the BIOS 22 automatically. The renewal software module 20 is triggered to search the schedule database and finds the next power-on time is 10:00:00 AM on August 14^{th}, which is within 24 hours. The renewal software module 20 therefore updates the BIOS 22's configuration to start the computer 10 at 10:00:00 AM on August 14^{th}. Then the renewal software module 20 determines that timing is not right to power on and shuts down the computer 10. After the computer 10 is shut down and when the actual scheduled power-on date and time (i.e., 10:00:00 AM on August 14^{th}) have expired, the computer 10 is powered on automatically by the BIOS 22 at the exact date and time that the user 14 has specified. This daily BIOS reconfiguration would effectively obviate the limitation of BIOS that can only accept scheduled power-on date and time within the next 24 hours. The objective of the present invention for multiple scheduled automatic powers-on is thereby achieved.

The present invention can further allow a user to specify in the schedule event what task to execute based on a power-on condition and whether to shut down the computer after the task is executed. There are three types of power-on condition: (a) the computer is powered on automatically as scheduled; (b) the computer is powered on manually by a user; and (c) the computer is already powered on (e.g., the computer is powered on automatically earlier but is not shut down afterwards). Based on the power-on condition, a user can specify different task to execute or shutting down the computer, corresponding to each of the three types of power-on condition.

The foregoing power-on flag could be embodied as a flag in the BIOS or other firmware. By examining this flag, what causing the computer to power on could be determined accurately.

If the BIOS 22 is configured to ask for a password from the user 14 when it is powered on, the present invention could read the original password from the BIOS and save it in a storage device of the computer 10 which includes, but not limited to, hard disk, floppy disk, RAM, flash memory, writable laser disk, and magnetic tape. The present invention then reconfigures the BIOS 22 not to ask for a password when the computer 10 is powered on automatically. When no automatic power-on is required, the present invention could read the stored password, save it bask to BIOS 22, and restores the BIOS 22's original configuration (i.e., requiring a password when powered on).

The present invention could further provides a configuration setting in the BIOS 22 so that, when BIOS 22 is configured to request a password and when the computer 10 is powered on, the BIOS 22 could determine whether the computer 10 is powered on automatically and, if yes, the BIOS 22 would automatically skip the step of requesting a password and continue the power-on sequence without pausing for password. That is, with this added BIOS configuration setting, the BIOS 22 could continue to ask for password when the computer 10 is powered on manually. But when the computer 10 is powered on automatically, BIOS 22 would not pause for password.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of scheduling multiple automatic powers-on for a computer having a BIOS with an automatic power-on function for starting said computer at a specific date and time, comprising the steps of:
(a) providing a schedule database for storing at least a schedule event, said schedule event specifying at least a date and time for powering on said computer;
(b) providing a renewal software module for reading said schedule database and configuring said BIOS automatic power-on function;
(c) triggering an execution of said renewal software module;
(d) searching said schedule database by said renewal software module for a schedule event whose scheduled date and time are closest and not expired yet; and
(e) configuring said automatic power-on function of said BIOS to power on said computer at said scheduled date and time.

2. The method as claimed in claim 1, wherein said schedule event is entered, updated, and deleted by a user through a user interface of an application program.

3. The method as claimed in claim 1, wherein said schedule event is entered, updated, and deleted by an application program without user intervention.

4. The method as claimed in claim 1, wherein said schedule event further specifies a task to be executed based on a power-on condition and whether to shut down said computer when said task is executed.

5. The method as claimed in claim 4, wherein said power-on condition indicates the following three circumstances: said computer is powered on by said BIOS automatic power-on function; said computer is powered on manually; and said computer is already powered on.

6. The method as claimed in claim 4, wherein said power-on condition is provided as a flag in said BIOS.

7. The method as claimed in claim 4, wherein said task is an execution of at least an application program.

8. The method as claimed in claim 4, wherein said task is a shutdown of said computer.

9. The method as claimed in claim 1, wherein said renewal software module is triggered by one of the following circumstances: an addition of a new schedule event into said schedule database, and a modification to an existing schedule event in said schedule database.

10. The method as claimed in claim 1, wherein said renewal software module is triggered after said BIOS automatic power-on function powers on said computer.

11. A method of scheduling multiple automatic powers-on for a computer having a BIOS with an automatic power-on function for starting said computer at a specific time within the next 24 hours, comprising the steps of:
(a) providing a schedule database for storing at least a schedule event, said schedule event specifying at least a date and time for powering on said computer;
(b) providing a renewal software module for reading said schedule database and configuring said automatic power-on function;
(c) triggering an execution of said renewal software module;
(d) searching said schedule database by said renewal software module for a schedule event whose scheduled date and time are closest and not expired yet;
(e) configuring said automatic power-on function to power on said computer at said time; and
(f) determining if current time is more than 24 hours away from said scheduled date and time, and, if yes, shutting down said computer.

12. The method as claimed in claim 11, wherein said schedule event is entered, updated, and deleted by a user through a user interface of an application program.

13. The method as claimed in claim 11, wherein said schedule event is entered, updated, and deleted by an application program without user intervention.

14. The method as claimed in claim 11, wherein said schedule event further specifies a task to be executed under a power-on condition and whether to shut down said computer when said task is executed.

15. The method as claimed in claim 14, wherein said power-on condition indicates the following three circumstances: said computer is powered on by said automatic power-on function; said computer is powered on manually; and said computer is already powered on.

16. The method as claimed in claim 14, wherein said power-on condition is provided as a flag in said BIOS.

17. The method as claimed in claim 14, wherein said task is an execution of at least an application program.

18. The method as claimed in claim 14, wherein said task is a shutdown of said computer.

19. The method as claimed in claim 11, wherein said renewal software module is triggered by one of the following circumstances: an addition of a new schedule event into said schedule database, and a modification to an existing schedule event in said schedule database.

20. The method as claimed in claim 11, wherein said renewal software module is triggered after said BIOS automatic power-on function powers on said computer.
